(19) United States
(12) Patent Application Publication
(10) Pub. No.: US 2022/0267978 A1
(43) Pub. Date: Aug. 25, 2022

(54) Modular Center Post, Associated Kit and Associated Method

(71) Applicant: Midwest Perma-Column, Inc., Edwards, IL (US)

(72) Inventor: Phil David Ehnle, Princeville, IL (US)

(73) Assignee: Phil David Ehnle, Princeville, IL (US)

(21) Appl. No.: 17/671,746

(22) Filed: Feb. 15, 2022

Related U.S. Application Data
(60) Provisional application No. 63/152,538, filed on Feb. 23, 2021.

(51) Int. Cl. E02D 5/30; E05D 15/06; E02D 5/48

(52) U.S. Cl. CPC E02D 5/30; E05D 15/0656; E02D 5/48

(57) ABSTRACT

A kit for use to support a building member such as a guide for a door for use in post frame construction includes a column defining a longitudinal axis of the column. The column has opposed first and second ends. The kit further includes a connector extending from the first end of the column. The connector has a first set of connecting features and a second set of connecting features. The second set of connecting features is at least partially distinct from the first set of connecting features. The kit further includes a first physical feature for engaging the building member and a second physical feature for engaging the building member. The second physical feature has at least one feature different from the corresponding feature of the first physical feature. The first set of connecting features secures the first physical feature to the column and the second set of connecting features secures the second set of physical features to the column.

### CROSS REFERENCE TO RELATED APPLICATION

This application is a non-provisional application and claims priority to U.S. Provisional Patent Application 63/152,538 filed Feb. 23, 2021 for “MODULAR CENTER POST, ASSOCIATED KIT AND ASSOCIATED METHOD”, which is hereby incorporated by reference in its entirety.

### BACKGROUND

The field of the disclosure relates generally to building construction, and more specifically, to support posts for post frame building construction.

Many agricultural and industrial buildings are used to protect and store agricultural machinery, industrial machinery, raw goods, and finished goods, as well as to house assembly and fabrication manufacturing operations. These buildings use a variety of construction arrangements including metal and wood framing with slab and block foundations. One of many construction arrangements consist of a series of vertically installed columns or poles made of treated wood. Wood or other material framing is secured to the columns to form the walls, roofs and ceilings of the buildings. Metal or vinyl sheets are used to form the walls and roofs of the buildings.

To provide access for large machines, large goods and large equipment to be placed in the buildings, large opening in the buildings are needed and are typically covered or closed by a pair of large sliding doors that meet in the middle of the large openings. The large sliding doors are supported at the top of the doors.

A guide normally extends upwardly from the floor of the building and guides or limits the sideward motion of the bottom of the doors, particularly at the middle of the opening. The doors may abut or slightly pass by each other at the middle of the opening.

Since the guide extends upwardly from the floor of the building, it is subject to being struck from the side and run over by large, very heavy equipment while the doors are open. Being routinely struck and run over, the guide may easily get worn and severely damaged and may require repair or replacement. The guide may cause damage to very expensive equipment, when struck by the same.

The guide is typically mounted to a treated wooden post that is buried below the floor of the building. The wooden post collects moisture below the ground, making it subject to rotting, requiring the post to be excavated and replaced.

The series of vertically installed columns or poles that together with the framing and the metal or vinyl sheets are, similarly to the wooden post to which the guide is mounted, buried below the floor of the building. These series of vertically installed columns or poles are likewise subject to rotting, requiring the columns or poles to be excavated and replaced.

### BRIEF DESCRIPTION

According to an aspect of the present invention, a support for use in post frame construction is provided. The support includes a column defining a longitudinal axis thereof and having opposed first and second ends. The support also includes a stop extending from the second end of the column. The stop is selectively moveable with respect to the column along the longitudinal axis of the column.

In another aspect, the support may be configured wherein the column includes a core having an elongated stem and a body extending radially outwardly from the core.

In another aspect, the support may be configured wherein the body includes concrete.

In another aspect, the support may be configured wherein the column includes a threaded member extending downwardly along the longitudinal axis and wherein the stop defines threads configured to engage the threaded member.

In another aspect, the support may be configured such that it further includes a connector extending from the first end of the column.

In another aspect, the support may be configured such that it further includes a guide that cooperates with a sliding door and is removeably connected to the connector.

In another aspect, the support may be configured such that it further includes a spacer extending from the connector and engaging the guide.

According to another aspect of the present invention, a support for use in post frame construction is provided. The support includes a column defining a longitudinal axis of the column and having opposed first and second ends. At least a portion of the column is made of concrete.

In another aspect, the support may be configured wherein the column includes an elongated stem and a body extending radially outwardly from the stem.

In another aspect, the support may be configured wherein at least a portion of the stem includes a metal rod.

In another aspect, the support may be configured wherein at least a portion of the body includes concrete.

In another aspect, the support may be configured such that it further includes a selectively moveable stop extending from the second end of the column. The stop is selectively moveable with respect to the column along the longitudinal axis of the column.

In another aspect, the support may be configured wherein the column includes a threaded member extending downwardly along the longitudinal axis of the column and wherein the stop defines threads configured to engage the threaded member.

In another aspect, the support may be configured such that it further includes a connector extending from the first end of the column.

In another aspect, the support may be configured such that it further includes a guide configured to cooperate with a sliding door and to be removeably connected to the connector.

In another aspect, the support may be configured such that it further includes a spacer extending from the connector and engaging the guide.

According to another aspect of the present invention, a support for use with physical features to engage a building member of a post frame building is provided. The support includes a column having a longitudinal axis of the column and opposed first and second ends. The support also includes a connector extending from the first end of the column. The connector includes a plurality of sets of physical features with a selected one of the plurality of sets of physical features for engaging the building member.

In another aspect, the support may be configured wherein at least a portion of the column is made of concrete.

In another aspect, the support may be configured wherein the column has an elongated stem and a body extending radially outwardly from the stem.

In another aspect, the support may be configured wherein at least a portion of the stem includes a metal rod.

In another aspect, the support may be configured wherein at least a portion of the body includes concrete.

In another aspect, the support may be configured such that it further includes a selectively moveable stop extending from the second end of the column. The stop is selectively moveable with respect to the column along the longitudinal axis of the column.

In another aspect, the support may be configured wherein the column includes a threaded member extending along the longitudinal axis of the column and wherein the stop defines threads configured to engage the threaded member.

In another aspect, the support may be configured such that it further includes a first set of physical features configured to engage the building member of the post frame building. The first set of physical features is removeably connected to the support.

In another aspect, the support may be configured such that it further includes a spacer extending from the connector and engaging the guide.

In another aspect, a kit for engaging a selected one of a plurality of building members of a post frame building is provided. The kit includes a column defining a longitudinal axis thereof and having opposed first and second ends and a connector.

The connector extends from the first end of the column. The connector includes a first set of connecting features and a second set of connecting features. The second set of connecting features is at least partially distinct from said first set of connecting features.

The kit also includes a first building member having a first set of physical features for cooperating with the first set of connecting features for securing the first building member to the column and a second building member.

The second building member has a second set of physical features for cooperating with the second set of connecting features for securing the second building member to the column. The second set of physical features has at least one feature different from the corresponding feature of the first set of physical features.

In another aspect, the kit may be configured wherein at least a portion of the column is made of concrete.

In another aspect, the kit may be configured wherein the column includes an elongated stem and a body extending radially outwardly from the stem.

In another aspect, the kit may be configured wherein at least a portion of the stem includes a metal rod.

In another aspect, the kit may be configured such that it further includes a selectively moveable stop extending from the second end of the column. The stop is selectively moveable with respect to the column along the longitudinal axis of the column.

In another aspect, the kit may be configured wherein the column includes a threaded member extending along the longitudinal axis of the column and wherein the stop defines threads configured to engage the threaded member.

In another aspect, the kit may be configured such that it further includes a spacer extending from the connector and engaging the guide.

According to another aspect of the present invention, a support for use to support a guide for a sliding door for use in post frame construction is provided. The support includes a column defining a longitudinal axis of the column and has opposed first and second ends. The support also includes a stop extending from the second end of the column. The stop is selectively moveable with respect to the column along the longitudinal axis of the column.

In another aspect, the support may be configured wherein the column includes a core including an elongated stem and a body extending radially outwardly from the core.

In another aspect, the support may be configured wherein the body includes concrete.

In another aspect, the support may be configured wherein the column includes a threaded member extending along the longitudinal axis and wherein the stop defines threads configured to engage the threaded member.

In another aspect, the support may further include a connector extending from the first end of the column.

In another aspect, the support may be configured such that it further includes a guide configured to cooperate with the sliding door and to be removeably connected to the connector.

In another aspect, the support may be configured such that it further includes a spacer extending from the connector and engaging the guide.

According to another aspect of the present invention, a support for use to support a guide for a sliding door for use in post frame construction is provided. The support includes a column defining a longitudinal axis of the column. The column has opposed first and second ends. At least a portion of the column is made of concrete.

In another aspect, the support may be configured wherein the column includes an elongated stem and a body extending radially outwardly from the stem.

In another aspect, the support may be configured wherein at least a portion of the stem includes a metal rod.

In another aspect, the support may be configured wherein at least a portion of the body is made from concrete.

In another aspect, the support may be configured such that it further includes a selectively moveable stop extending from the second end of the column. The stop is selectively moveable with respect to the column along the longitudinal axis of the column.

In another aspect, the support may be configured such that the column includes a threaded member extending along the longitudinal axis of the column and wherein the stop defines threads configured to engage the threaded member.

In another aspect, the support may be configured such that it further includes a connector extending from the first end of the column.

In another aspect, the support may be configured such that it further includes a guide configured to cooperate with the sliding door and to be removeably connected to the connector.

In another aspect, the support may be configured such that it further includes a spacer extending from the connector and engaging the guide.

According to another aspect of the present invention, a support for use to support a guide for a sliding door for use in post frame construction is provided. The support includes a column defining a longitudinal axis of the column. The column has opposed first and second ends. The support further includes a connector extending from the first end of the column. The connector includes a plurality of sets of physical features with a selected one of the plurality of sets of physical features for engaging the building member.

In another aspect, the support may be configured wherein at least a portion of the column is made of concrete.

In another aspect, the support may be configured wherein the column includes an elongated stem and a body extending radially outwardly from the stem.

In another aspect, the support may be configured wherein at least a portion of the stem includes a metal rod.

In another aspect, the support may be configured wherein at least a portion of the body is made from concrete.

In another aspect, the support may be configured such that it further includes a selectively moveable stop extending from the second end of the column. The stop is selectively moveable with respect to the column along the longitudinal axis of the column.

In another aspect, the support may be configured wherein the column includes a threaded member extending along the longitudinal axis of the column and wherein the stop defines threads configured to engage the threaded member.

In another aspect, the support may be configured such that it further includes a first set of physical features configured to engage the door of the post frame building. The set of physical features is removeably connected to the connector.

In another aspect, the support may be configured such that it further includes a spacer extending from the connector and engaging the guide.

According to another aspect of the present invention, a kit for engaging a selected one of a plurality of guides for guiding the door of a post frame building is provided. The kit includes a column defining a longitudinal axis thereof and having opposed first and second ends. The kit also includes a top plate extending from the first end of the column. The top plate includes a first set of connecting features and a second set of connecting features. The second set of connecting features is at least partially distinct from the first set of connecting features.

The kit also includes a first guide having a first set of physical features for cooperating with the first set of connecting features for securing the first guide to the column.

The kit also includes a second guide having a second set of physical features for cooperating with the second set of connecting features for securing the second guide to the column. The second set of physical features has at least one feature different from the corresponding feature of the first set of physical features.

In another aspect, the kit may be configured wherein at least a portion of the column is made of concrete.

In another aspect, the kit may be configured wherein the column includes an elongated stem and a body extending radially outwardly from the stem.

In another aspect, the kit may be configured wherein at least a portion of the stem includes a metal rod.

In another aspect, the kit may be configured such that it further includes a selectively moveable stop extending from the second end of the column. The stop is selectively moveable with respect to the column along the longitudinal axis of the column.

In another aspect, the kit may be configured wherein the column includes a threaded member extending along the longitudinal axis of the column and wherein the stop defines threads configured to engage the threaded member.

In another aspect, the kit may be configured such that it further includes a spacer extending from the connector and engaging the guide.

According to another aspect of the present invention, a method for providing a support for a selected one of a plurality of building members of a post frame building is provided. The method includes the step of providing a column defining a longitudinal axis of the column. The column has opposed first and second ends. The method further includes the step of providing a connector extending from the first end of the column. The connector includes a first set of connecting features and a second set of connecting features. The second set of connecting features is at least partially distinct from the first set of connecting features.

The method further includes the step of providing a first set of physical features for engaging a selected first of a plurality of building members.

The method further includes the step of providing a second set of physical features for engaging a selected second of a plurality of building members. The second set of physical features has at least one feature different from the corresponding feature of the first set of physical features. The first set of connecting features are adapted to secure the first set of physical features to the column and the second set of connecting features adapted to secure the second set of physical features to the column.

The method further includes the step of selecting one of the first set of physical features and the second set of physical features corresponding to a selected one of the first of a plurality of building members and the second of a plurality of building members.

The method further includes the step of securing the selected one of the first set of physical features and the second set of physical features to the column by connecting the selected one of the first set of physical features and the second set of physical features corresponding to a selected one of the first of a plurality of building members and the second of a plurality of building members to the column with the corresponding one of the first set of connecting features and the second set of connecting features.

According to another aspect of the present invention, a method for providing a support for a selected one of a plurality of sliding door guides of a post frame building is provided. The method includes the step of providing a column defining a longitudinal axis of the column. The column has opposed first and second ends. The method further includes the step of providing a connector extending from the first end of the column. The connector includes a first set of connecting features and a second set of connecting features. The second set of connecting features is at least partially distinct from the first set of connecting features.

The method further includes the step of providing a first set of physical features for engaging a selected first of a plurality of building members.

The method further includes the step of providing a second set of physical features for engaging a selected second of a plurality of sliding door guides. The second set of physical features has at least one feature different from the corresponding feature of the first set of physical features. The first set of connecting features are adapted to secure the first set of physical features to the column and the second set of connecting features adapted to secure the second set of physical features to the column.

The method further includes the step of selecting one of the first set of physical features and the second set of physical features corresponding to a selected one of the first of a plurality of sliding door guides and the second of a plurality of sliding door guides.

The method further includes the step of securing the selected one of the first set of physical features and the second set of physical features to the column by connecting the selected one of the first set of physical features and the second set of physical features corresponding to a selected one of the first of a plurality of sliding door guides and the second of a plurality of sliding door guides to the column with the corresponding one of the first set of connecting features and the second set of connecting features.

### BRIEF DESCRIPTION OF THE DRAWINGS

FIG. 1 is a elevational view of a door guide support according to an aspect of the present invention;

FIG. 2 is a perspective view of the door guide support of FIG. 1;

FIG. 3 is an elevational view of an elongated stem for use in the door guide support of FIG. 1;

FIG. 4 is perspective view of a spacer to be positioned between the door guide support and the door guide for use to raise the door guide relative to the ground for use in the door guide support of FIG. 1;

FIG. 5 is a perspective view of a connector for use in the door guide support of FIG. 1;

FIG. 6 is a perspective view of a guide for use with the door guide support of FIG. 1;

FIG. 7 is a perspective view of a pole frame building in which the door guide support of FIG. 1 may be used;

FIG. 8 is a perspective view of an adjustable pole support of FIG. 1 in use supporting one of the poles in the pole frame building of FIG. 7;

FIG. 9 is a perspective view of the door guide support of FIG. 1 in use guiding the sliding door of the pole frame building of FIG. 7;

FIG. 10 is a perspective view of a kit for providing the door guide support for use in guiding a sliding door of a pole frame building according to another aspect of the present invention;

FIG. 11 is a flow diagram of an exemplary method for providing a support for a selected one of a plurality of building members of a post frame building according to yet another aspect of the present invention; and

FIG. 12 is a flow diagram of another exemplary method for providing a door guide support for use in guiding a sliding door of a pole frame building according to yet another aspect of the present invention.

### DETAILED DESCRIPTION

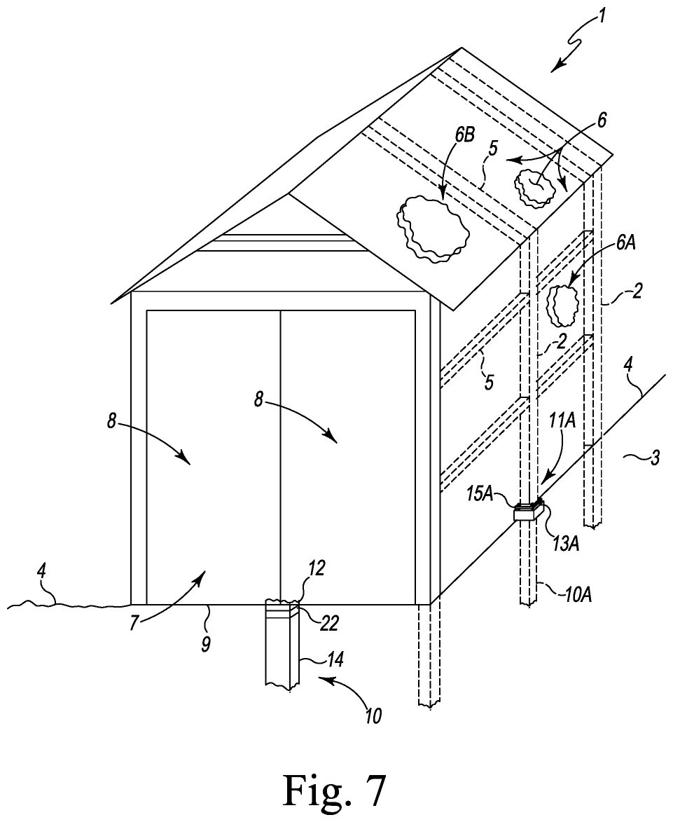

Referring now to FIG. 7, building 1 is shown. As shown, the building 1 is made of post frame construction, commonly known as a pole building. The building 1 includes a series of poles 2 which are positioned spaced apart and vertically oriented with a portion positioned in the ground or foundation 3 below the surface or floor 4 of the building 1. The poles 2 are typically of wood, composite or steel. Dimensional framing material 5 typically of wood, composite or steel are connected to the poles 2 by any suitable method such as nailing. Dimensional covering material 6 typically of wood, composite or steel forms walls 6A and roof 6B of the building 1. The building 1 includes at least one opening 7 for receiving large packages, machinery or equipment. The opening 7 may be selectively opened and closed with doors 8 that slide from the top of the doors 8. The doors 8 are typically unsupported at bottom 9 of the doors 8. The poles 2, framing material 5, dimensional covering material 6 and doors 8 may have any suitable size and shape and may be made of any suitable materials fabricated by any suitable manufacturing methods.

According to an aspect of the present invention, a guide or stop 12 is secured in the ground or foundation 3 of the building 1 by a vertically oriented support 10 extending downwardly into the ground. Pole supports 10A similar or identical to the support 10 may be used with the poles 2 to secure the poles 2 in the ground or foundation 3 of the building 1.

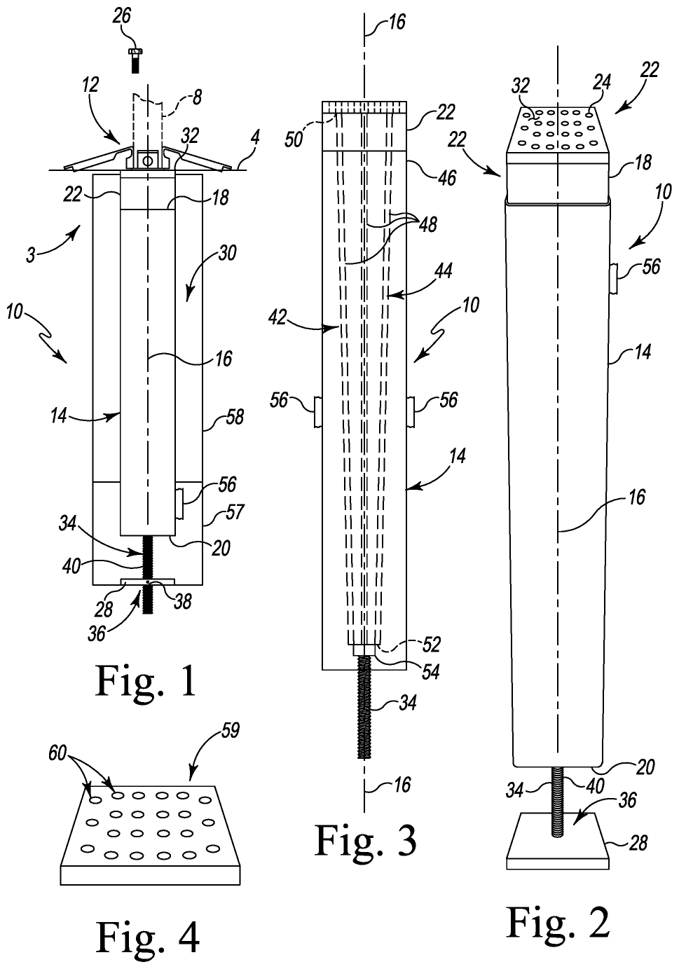

Referring now to FIG. 1 and according to an aspect of the present invention, the support 10 for use in post frame construction is provided. As shown in FIG. 1, the support 10 is for use to support the guide or stop 12 for sliding door 8 for use in post frame construction.

Referring again to FIG. 7, it should be appreciated that the support 10 may be utilized as pole support 10A to support any one of the poles 2 to support the building. Note that the pole support 10A may be identical or similar to support 10 as shown in greater detail in FIGS. 1-6. The pole support 10A may be connected to pole 2 by fasteners 11A connecting a support adaptor 13A secured to pole support 10A to a pole adaptor 15A secured to pole 2. The fasteners IA, connecting support adaptors 13A and pole adaptors 15A may have any suitable size and shape and may be made of any suitable materials fabricated by any suitable manufacturing methods.

Referring now to FIG. 2, the support 10 includes a column 14 defining a longitudinal axis 16 of the column 14. The column 14 has a first end 18 and an opposed second end 20.

The column 14 may have any suitable shape and may, for example, have a uniform cross section along the longitudinal axis 16. The shape may be tapered along the longitudinal axis 16 to permit the column to be removed from a mold during manufacturing, if molded in a vertical orientation. If the column 14 has a uniform shape, that shape may be, for example and simplicity, a simple shape, for example round, oval, triangular, square or rectangular. As shown in FIGS. 1-3, the column has a square cross section. The column 14 may have a cross section that is slightly tapered along opposed sides of the square cross section, to permit the column to be removed from a mold during manufacturing, if molded in a horizontal orientation.

Referring now to FIGS. 1 and 2 and according to another aspect of the invention, the support 10 further includes a connector 22. As shown, the connector 22 is connected to and extends upwardly from first end 18 of the column 14 of the support 10.

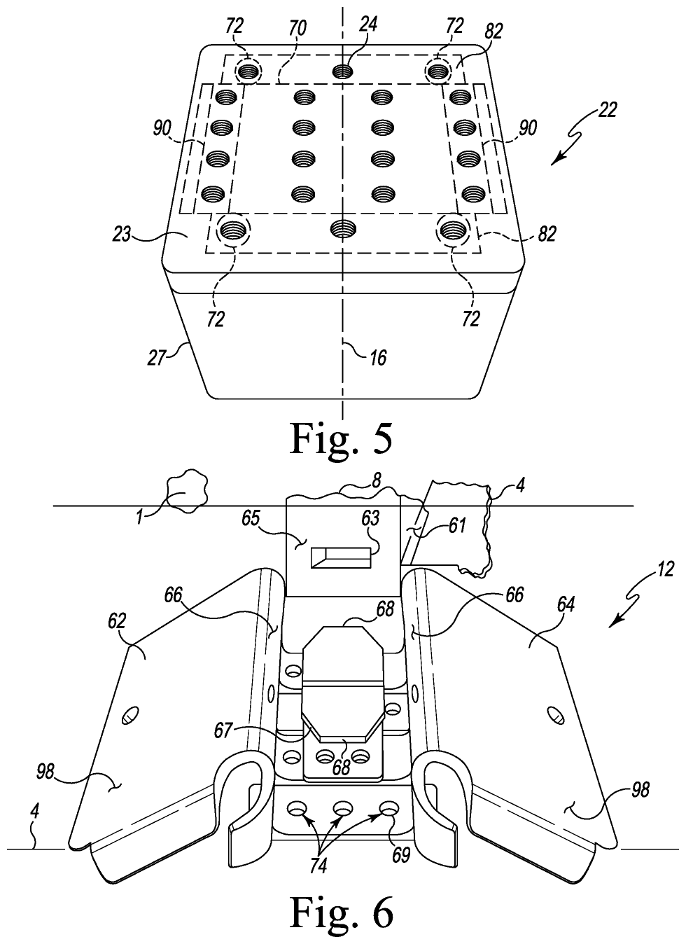

The connector 22 is used to connect the guide 12 to the column 14. The connector 22 may be made of any suitable material, for example a metal, a polymer or a composite. If made of a metal, for example, the connector 22 may be made of steel. The connector 22 may be cast, molded, forged, or, as shown in FIGS. 2 and 5, be formed from sheet metal. The connector 22 may be integral or, as shown in FIG. 5, be made of more than one component including a top component 23 and a side wall component 27.

The guide 12 may be made of any suitable material and may for example made of a polymer, metal or composite. If made of a metal, for example, The guide 12 may be made of steel. The guide may be cast, molded, forged, or, as shown in FIG. 6, be formed from sheet metal. The guide 12 may be integral or, as shown in FIG. 6, be made of more than one component.

As shown in FIGS. 1, 2 and 5, the connector 22 may be in the form of a top plate and may include a feature for engaging the guide 12. The feature may be pins, clamps a stud, a hook or any other removable fasteners or physical feature (not shown). For example and as shown in FIGS. 1 and 2, the feature for engaging the guide 12 may be in the form of a pattern of internally threaded openings 24. The openings 24 are utilized to receive threaded cap screws or bolts 26 which connect the guide 12 to the connector 22.

Continuing to refer to FIGS. 1 and 2 and according to another aspect of the invention, the column 14 may further include a stop 28 extending from the second end 20 of the column 14. The stop 28 may be made of any suitable material, for example a metal, a polymer or a composite, and may have any suitable shape which may, for simplicity, have a shape similar to the column 14. The stop 28 provides vertical positioning of the support 10 when it is installed in opening 30 formed in the ground 3 by, for example, augers (not shown) during the construction of the building 1.

According to another aspect of the invention, the stop 28 is selectively vertically moveable with respect to the column 14 along the longitudinal axis 16 of the column 14, causing the first end 18 of the column 14 to be vertically adjustable. The vertical adjustability of the column 14 permits top surface 32 of the top plate or connector 22 to be aligned with surface or floor 4 of ground 3.

According to another aspect of the invention, the vertical adjustability of the column 14 may be provided by having the column 14 of the support 10 further include a threaded member 34 extending downwardly from second end 20 of column 14 along the longitudinal axis 16 of column 14. The threaded member 34 may be made of any suitable material, for example a metal, for example a steel all thread rod (ATR). The stop 28 may include a centrally located internally threaded opening 36 with internal threads 38 configured to engage external threads 40 on the threaded member 34.

As shown in FIGS. 1 and 2, the top surface 32 of top plate 22 may be adjusted to be in alignment with the surface 4 of the ground 3 by rotating the top plate 22 and the column 14 about longitudinal axis 16 causing the threaded rod member 34 to rotate relative to the stop 28. Note that the stop 28 does not rotate as it is engaged with the ground 3 during the height adjustment.

The column 14 may be of an integral construction and may be made of a unity material, for example concrete, a metal, a polymer or a composite material. Alternatively, the column 14 may be constructed from a plurality of components and may be made from a plurality of materials.

Referring now to FIG. 3, according to an aspect of the present invention, in one such construction of the column 14, the column 14 may include a core 42 having an elongated stem 44 and a body 46 extending radially outwardly from the core 42.

It should be appreciated that the stem 44 may have any suitable shape and may for example may be made of a metal, for example steel, and may be in the form of reinforced bar or rebar. The stem may be a unitary component that is centrally located along longitudinal axis 16 of column 14. Alternately and as shown in FIG. 2 the stem 44 may include a plurality of rebar members 48, for example three rebar members 48 forming the general shape of a tripod with the a first end 50 of the stem 44 connected to top plate 22. The stem as shown also includes a second opposed end 52 includes an internally threaded member or nut 54 for receiving the ATR 34.

The nut 54 may be connected to the rebar members 48 by any suitable means and may be welded to the rebar members 48. Similarly, the top plate 22 may be connected to the rebar members 48 by any suitable means and may be welded to the rebar members 48.

Referring now to FIG. 3, according to an aspect of the present invention, in one construction of the column 14, the body 46 of the column 14 may surround or encase the core 42. As shown, the body 46 may be made of any suitable durable material that may be formed or poured to surround the stem 44 of the core 42.

In another aspect and as shown in FIGS. 1-3, the support 10 may be configured wherein the body 46 is made of concrete. The concrete body 46 is formed around the stem 44 of the core 42 and surrounds or encases the stem 44 of the core 42. The core 42 serves to strengthen the column 14 and provides significant tensile strength to the column 14.

In another aspect, the body 46 of the column 14 may be made by pouring concrete into a mold 56. When being molded, the column 14 may be oriented with the longitudinal axis 16 positioned horizontally or alternatively vertically. The body 46 of the column 14 may be tapered to ease the removal of the body 46 from the mold 56 upon hardening of the concrete.

As shown in FIGS. 1-3, the top plate 22 extends upwardly from first end 18 of the column 14 and is secured to the column 14 by the concrete body 46. Similarly the ATR 34 extends downwardly from second end 20 and is secured to the column 14 by the concrete body 46.

Referring again to FIG. 1, the support 10 may, as shown, be mounted in the ground 3. The support opening 30 is formed in the ground 3 by, for example, augers (not shown) during the construction of the building 1. The opening is formed with, for example, the cylindrical support opening 30 being significantly larger in diameter than the column 14 of the support 10. The support 10 is installed with the stop 28 pointed downwardly and the top plate 22 positioned upwardly. The stop 28 engages the bottom of the opening 30. The support 10 is rotated to raise or lower the column 14 so that the top plate 22 is in alignment with the floor or surface 4 of the ground 3.

The column 14 is positioned with the longitudinal axis 16 of the column 14 positioned centrally in the support opening 30. Anchoring cement or concrete 57 is poured into the bottom portion of the support opening 30 and, while the column 14 is positioned centrally, is allowed to cure or harden. After the concrete 57 is hardened, filling material 58, for example stone and/or dirt, is used to complete filling the opening 30 between the column 14 and the inner walls of the opening 30. The stone and or dirt 58 is then tamped to further provide for a secure placement of the support 10.

While the position of the top surface 32 of top plate 22 with respect to the floor 4 of the ground 3 may be accurately positioned using the stop 28 of FIG. 1, it should be appreciated that, once the concrete 57 has hardened, the top surface 32 of the top plate 22 may not be further raised or lowered. Also, the position of the top surface 32 of top plate 22 with respect to the surface 4 of the foundation 3 may change, more likely fall or lower over time, as the column 14 of the support 10 sinks into the ground 3.

In another aspect and as shown in FIGS. 2-4, the height of the support 10 for the door stop 12 may be adjusted by adding one or more spacers or plates 59 (only one spacer 59 is shown in FIG. 4) between the top surface 32 of top plate 22 and the door stop 10. It should be appreciated that one or more spacers 59 may be used during the initial installation of the door stop 12. These initially installed spacers 59 may be removed if the door stop 12 as initially installed or later becomes too high. Conversely, additional spacers 59 may be added if the door stop 12 as initially installed or later becomes too low.

It should be appreciated that to permit the bolts 26 to be used to secure the door stop 12 to the top plate 22, the spacer 59 may further include clearance holes 60 to permit the bolts 26 to pass through the top plate 22. The clearance holes 60 may, as shown, have a hole pattern matching the hole pattern of the threaded openings 24 in the plate 22.

Note that the spacers 59 may have any suitable size and may have any suitable thickness or varying thicknesses. The spacers 59 may be made of any suitable material, such as a metal, for example steel.

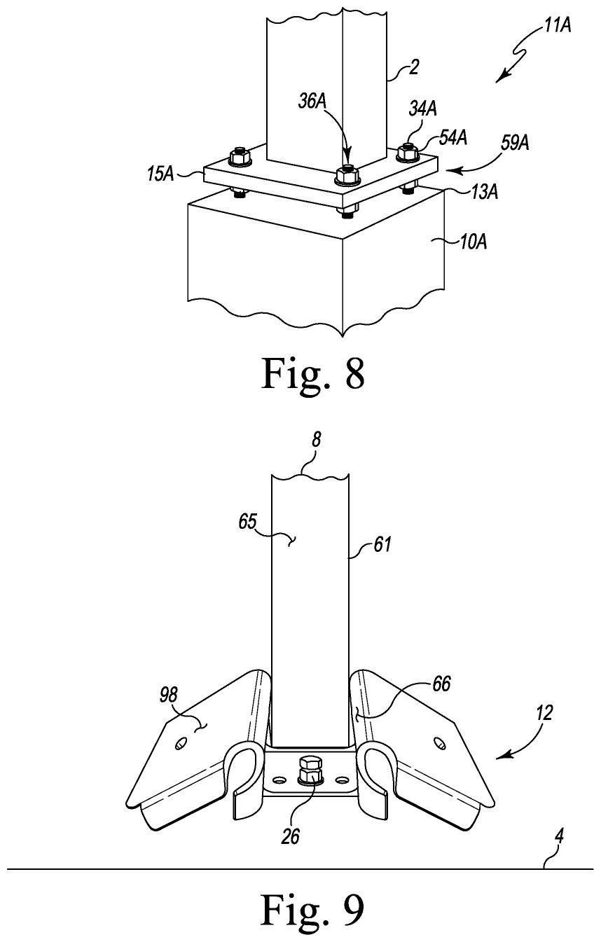

The height of the plate 22 may be adjusted after the concrete 57 has hardened with any other suitable height adjustment device, such as wedges, turnbuckles or other suitable devices. One such device to adjust the plate height is height adjustment device 59A, shown in FIG. 8, in use to adjust the height of a pole 2.

In another aspect and as shown in FIGS. 1-7, the guide 12 is shown mounted onto top plate 22. The guide 12 is used to guide a building member of a building, for example, post frame building 1. The guide 12, for example, typically extends upwardly from the floor 4 of the building 1 and may, for example, guide or limit a building member in the form of a door 8. For example, the guide 12 may, for example, guide or limit the sideward motion of bottom 9 of the doors 8, particularly at the middle of the opening 7. The doors 8 may abut or slightly pass by each other at the middle of the opening 7.

The guide 12 may be made of any suitable material and may, for example, be made of a polymer, metal or composite. If made of a metal, for example, the guide 12 may be made of steel. The guide 12 may be cast, molded, forged, or, as shown in FIG. 6, be formed from sheet metal. The guide 12 may be integral or, as shown in FIG. 6, be made of more than one component. As shown in FIG. 6, the guide 5 may include a left guide 62, a right guide 64 and a door channel guide 67.

As shown in FIGS. 1, 6 and 9, the guide 12 may engage any portion of the doors 8. For example, the guide 12 may include features to engage any external portion of the doors 8. For example, the guide 12 may have features to engage outer side faces 61 of the doors 8 and or a feature 63 on an end face 65 of doors 8.

In another aspect and as shown in FIG. 6, the guide 12 may include inner faces 66 that engage outer side faces 61 of the doors 8. Alternatively or in addition and as shown in FIG. 6, the guide 12 may include end engaging features 68 that engage the feature 63 on the end face 65 of doors 8. Note that the feature 63 may be in the form of an internal channel formed along the entire length of the door 8. The feature 63 and the guide 12 may be used to prevent the door 8 from swaying outwardly, while a concrete floor 4 may prevent the door 8 from swaying inwardly.

As shown in FIG. 6, the end engaging features 68 of the guide 12 are in the form of protrusions that engages feature 63 in the form of a channel extending along the bottom of the doors 8 toward the end face 65 of doors 8.

The guide 12 may be made of any suitable durable material and be of any suitable size and construction. The guide 12 as shown in FIG. 6 may be available from CannonBall HNP, Janesville, Wis.

As shown in FIGS. 1, 5, 6 and 9, the guide 12 engages the connector or top plate 22 of the support 10. The guide 12 may engage the top plate 22 in any suitable manner, such as with top plate connecting features 24 associated with the top plate 22 in the form of, for example, pins, clamps, a stud, a hook or any other top plate connecting features associated with the top plate 22.

For example and as shown in FIGS. 1, 5, 6 and 10, the top plate connecting features of the top plate 22 for engaging the guide 12 may be in the form of a pattern of internally threaded openings 24. The internally threaded openings 24 of the top plate 22 are utilized with connecting features 69 of the guide 12 in the form of unthreaded clearance openings 69 to receive threaded cap screws or bolts 26 which connect the guide 12 to the top plate 22 at the internally threaded openings 24 of the top plate 22.

In another aspect and referring now to FIG. 8, height adjustment device 59A is shown. The height adjustment device 59A is, as shown, utilized to adjust the height of pole 2 in pole building 1 (see FIG. 7). The height adjustment device 59A is in the form of a plurality (4 as shown) of threaded rod members or all thread rods (ATRs) 34A similar to ATRs 34 that form a portion of support adapter 13A. The ATRs 34 extend upwardly from pole support 10A. The pole 2 includes pole adapter 15A in the form of a flange extending outwardly from the bottom of pole 2. The adapter 15A has a plurality of through openings 36A through which the ATRs pass. Fasteners 11A, including nuts 54A, threadably engage the ATRs on both sides of the flange 15A. The nuts 54A can be raised and lowered to adjust the height of the pole 2. Note that the height adjustment device 59A may be utilized on the support 10 for supporting the door guide 12. Note that the height adjustment device 59A may have any suitable size and be made of any suitable materials, for example metal.

In another aspect, the connector or top plate 22 may be configured to accommodate more than one type, style or configuration of a building member such as a guide or support for a pole. For example and as shown in FIG. 5, the top plate 22 may include may include more than one set of top plate connecting features.

For example and according to another aspect, the top plate 22 may have top plate connecting features 24, such as the threaded holes 24 that may include a first set of connecting features 70 and a second set of connecting features 72. The second set of physical features 70 is at least partially distinct from the first set of physical features 72.

Referring now to FIGS. 5-10, the first set of connecting features 70 shown in FIG. 5 are sixteen (16) of the twenty four (24) threaded holes in the top plate 22.

As can be seen in FIG. 6, the first set of connecting features 70 or sixteen (16) threaded holes are spaced apart in an arrangement to mate with a first set of physical features 74 in the building member or guide 12.

As shown in FIG. 6, the first set of physical features 74 in the guide 12 represent twelve (12) of the unthreaded openings 69 in the guide 12. Bolts 26 (see FIG. 1) are used to connect the guide 12 to the top plate 22. One of twelve (12) bolts 26 is placed in each of the unthreaded openings 69 in the guide 12. Further, one of twelve (12) bolts 26 is threadably engaged with a selected one of twelve (12) of the sixteen (16) threaded holes in the top plate 22.

Referring to FIGS. 1 and 5 and according to another aspect, the first set of connecting features 70 in the top plate 22 include a pattern of sixteen (16) threaded holes that are symmetric around longitudinal axis 16 allowing the assembly of the guide 12 to the top plate 22 in two orientations, each 180 degrees apart. This symmetric relationship permits the column 14 of the support 10 to be oriented in two directions, each 180 degrees apart, when the column is installed in the opening 30 in the ground 3. Note that, as the column 14 is rotated, the top surface 32 of the top plate 22 raises or lowers, so that the top surface 32 may be aligned with the surface 4 of the ground 3. Note that each 180 degrees of rotation of the column 14 raises or lowers the guide 12 so that the guide 12 may be aligned with the bottom 9 of the door 8.

Note that each of the two relative locations of the guide 12 with respect to the top plate 22 defined by the 180 degrees of rotation of the column 14 with respect to the guide 12 define one of two connecting configurations of the first set of connecting features 70 in the top plate 22 to the first set of physical features 74 in the guide 12. Note that in each of these two connecting configurations of the first set of connecting features 70 in the top plate 22 to the first set of physical features 74 in the guide 12, only 12 of the 16 threaded holes 24 of the top plate 22 are utilized. In other words, the first set of connecting features 70 including 12 of the 16 threaded holes 24 of the top plate 22, the twelve (12) bolts 26, and the first set of physical features 74 including the 12 unthreaded holes 69 of the guide 12 are used to secure the guide 12 to the top plate 22.

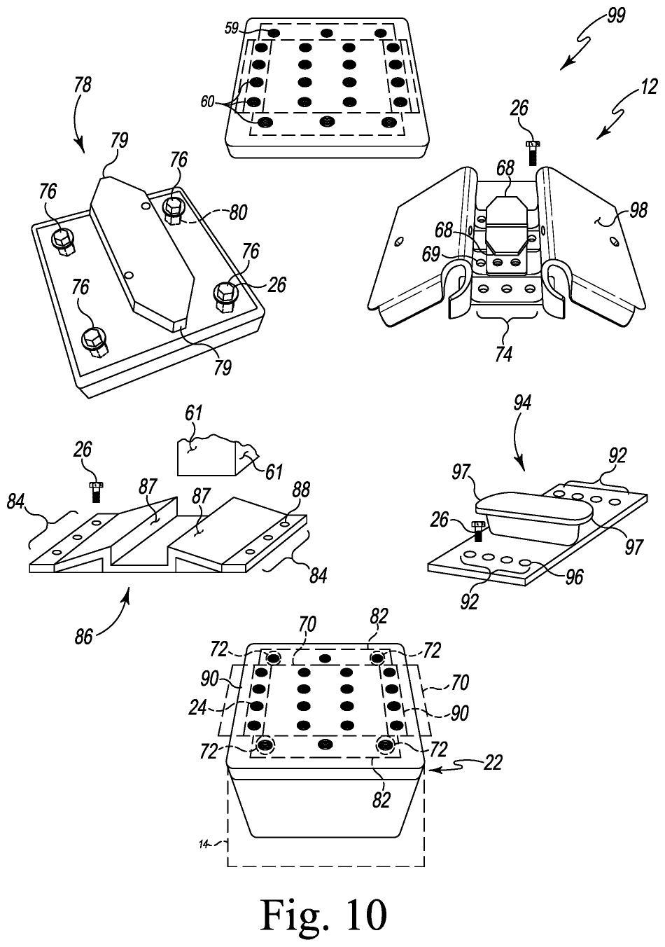

As shown in FIGS. 5 and 10 and according to an aspect, the second set of connecting features 72 may be utilized to connect the top plate 22 of the support 10 to a second set of physical features 76. As shown in FIGS. 5 and 10 the second set of physical features 76 is located in second guide 78. The second guide 78 defines the second set of physical features 76. As shown in FIGS. 5 and 10 the second set of physical features 76 includes a set of unthreaded openings 80.

As shown in FIG. 10, the second guide 78 includes a protrusion 79 that engages a mating end door feature (not shown) on door outer end faces of door. The end door feature may be a channel running the length of the door at the bottom of the door.

The second guide 78 may be made of any suitable durable material and be of any suitable size and construction. The second guide 78 as shown in FIG. 10 may be available from Midwest Perma-Column Inc., Edwards, Ill.

For example and as shown in FIGS. 5 and 10 and in another aspect, the second set of connecting features 72, shown in FIG. 5, are four (4) of the twenty four (24) threaded holes in the top plate 22. As can be seen in FIGS. 5 and 10, the second set of connecting features 72 or four (4) threaded holes are spaced apart in an arrangement to mate with a second set of physical features 76 in the second guide 78.

As shown in FIG. 10, the second set of physical features 76 in the second guide 78 represent four (4) unthreaded openings 80 in the second guide 78. Bolts 26 are used to connect the second guide 78 to the top plate 22. One of four (4) bolts 26 is placed in each of the unthreaded openings 80 in the second guide 78. Further, one of four (4) bolts 26 is threadably engaged with one of the four (4) threaded holes 24 in the top plate 22.

The second set of connecting features 72 in the top plate 22 includes a pattern of four (4) threaded holes that are symmetric around longitudinal axis 16 allowing the assembly of the second guide 78 to the top plate 22 in at least two orientations, each 180 degrees apart. Note that if the top plate 22 is square, there are four orientations, each 90 degrees apart. This symmetric relationship permits the column 14 of the support 10 to be oriented at least in two directions, each 180 degrees apart when the column 14 is installed in the opening 30 in the ground 3. Note that, as the column 14 is rotated, the top surface 32 of the top plate 22 raises or lowers, so that the top surface 32 may be aligned with the surface 4 of the ground 3. Note that each 180 degrees of rotation of the column 14 raises or lowers the second guide 78 so that the second guide 78 may be aligned with the bottom 9 of the door 8.

As shown in FIGS. 5 and 10 and according to an aspect, a third set of connecting features 82 may be utilized to connect the top plate 22 of the support 10 to a third set of physical features 84. As shown in FIGS. 5 and 10 the third set of physical features 84 are located in a third guide 86. The third guide 86 may include features different than the first guide 22 or second guide 78. The third guide 86 may only be different from the first guide 22 or second guide 78 in how it is connected to the support 10. The third set of connecting features 82 secures the third guide 86 to the column 14.

As shown in FIG. 10, the third guide 86 includes a feature in the form of inner faces 87 that engage outer faces 61 of door 8.

For example and as shown in FIGS. 5 and 10 and in another aspect, the third set of connecting features 82 shown in FIG. 5 are six (6) of the twenty four (24) threaded holes in the top plate 22. As can be seen in FIG. 5, the third set of connecting features 82 or six (6) threaded holes are spaced apart in an arrangement to mate with a third set of physical features 84 in the third guide 86. As shown in FIG. 6, the third set of physical features 84 in the third guide 86 represent six (6) unthreaded openings 88 in the third guide 86. Bolts 26 are used to connect the third guide 86 to the top plate 22. One of six (6) bolts 26 is place in each of the unthreaded openings 88 in the third guide 86. Further, one of six (6) bolts 26 is threadably engaged with one of the six (6) threaded holes in the top plate 22.

The third set of connecting features 82 in the top plate 22 include a pattern of six (6) threaded holes that are symmetric around longitudinal axis 16 allowing the assembly of the third guide 86 to the top plate 22 in two orientations, each 180 degrees apart. This symmetric relationship permits the column 14 of the support 10 to be oriented in two directions, each 180 degrees apart when the column 14 is installed in the opening 30 in the ground 3. Note that, as the column 14 is rotated, the top surface 32 of the top plate 22 raises or lowers, so that the top surface 32 may be aligned with the surface 4 of the ground 3. Note that each 180 degrees of rotation of the column 14 raises or lowers the third guide 86 so that the third guide 86 may be aligned with the bottom 9 of the door 8.

As shown in FIGS. 5 and 10 and according to an aspect, a fourth set of connecting features 90 may be utilized to connect the top plate 22 of the support 10 to a fourth set of physical features 92. As shown in FIG. 10, the fourth set of physical features 92 are located in a fourth guide 94. The fourth guide 94 may include features different than the first guide 22, second guide 78 or third guide 86. The fourth guide 94 may only be different from the first guide 22, second guide 78 or third guide 86 in how it is connected to the support 10. The fourth set of connecting features 90 secures the fourth guide 94 to the column 14.

For example and as shown in FIGS. 5 and 10 and in another aspect, the fourth set of connecting features 90 shown in FIG. 5 are eight (8) of the twenty four (24) threaded holes in the top plate 22. As can be seen in FIG. 6, the fourth set of connecting features 90 or eight (8) threaded holes are spaced apart in an arrangement to mate with the fourth set of physical features 92 in the fourth guide 94.

As shown in FIG. 6, the fourth set of physical features 92 in the fourth guide 94 represent eight (8) unthreaded openings 96 in the fourth guide 94. Bolts 26 are used to connect the fourth guide 94 to the top plate 22. One of eight (8) bolts 26 is place in each of the unthreaded openings 96 in the fourth guide 94. Further, one of eight (8) bolts 26 is threadably engaged with one of the eight (8) threaded holes in the top plate 22.

The fourth set of connecting features 90 in the top plate 22 include a pattern of eight (8) threaded holes that are symmetric around longitudinal axis 16 allowing the assembly of the fourth guide 94 to the top plate 22 in two orientations, each 180 degrees apart. This symmetric relationship permits the column 14 of the support 10 to be oriented in two directions, each 180 degrees apart when the column 14 is installed in the opening 30 in the ground 3. Note that, as the column 14 is rotated, the top surface 32 of the top plate 22 raises or lowers, so that the top surface 32 may be aligned with the surface 4 of the ground 3. Note that each 180 degrees of rotation of the column 14 raises or lowers the fourth guide 94 so that the fourth guide 94 may be aligned with the bottom 9 of the door 8.

As shown in FIG. 10, the fourth guide 94 includes a protrusion 97 that engages a mating end door feature (not shown) on door outer end faces 65 of door 8.

Further additional guides (not shown) may include features different than those of the first guide 22, second guide 78, third guide 86 or fourth guide 94. The additional guides may only be different from the first guide 22 in how it is connected to the support 10. In other words, one of the additional guides, the needed number of bolts 26, and the needed number of threaded holes 24 may be used to secure any one of the additional guides to the top plate 22.

It should be appreciated that any combination of the threaded holes 24 of the top plate 22 may alternatively be used to secure the column 14 to a pole adaptor 15A to support one of the poles 2.

Referring now to FIGS. 6-9, since the guide 22 extends upwardly from the floor 4 of the building 1, it is subject to being struck from the side and run over by large very heavy equipment while the doors 8 are open. As such, providing the guide 22 with a low profile and with opposed ramps 98 (see FIG. 6) is preferred to keep damage to the equipment minimized when the doors are open.

Since the guide 22 may be easily and inexpensively replaced and since the large very heavy equipment is very expensive it may be desirable to provide a guide that provides minimum damage to large very heavy equipment. Since doors 8 may be expensive and may cause extensive damage to large very heavy equipment when equipment accidently strikes the doors, it may desirable to provide a guide that may separate under extreme force from the top plate 22 of the column 14. The bolts 26 that are used to secure the guide 22 to the top plate 22 may be sized to permit them to be sheared under such extreme force when equipment accidently strikes the doors before great damage is done to the doors or to the large equipment.

According to another aspect and referring now to FIG. 10, a kit 99 for engaging a building member such as guide 22 or a pole support 10A of a post frame building 1 is provided. The kit includes a column 14 defining a longitudinal axis 26 of the column 14. The column 14 has first end 18 and opposed second end 20.

The kit 99 also includes a connector 22 in the form of, for example, an end plate extending from the first end 18 of the column 14. The end plate 22 has a first set of connecting features 70 and a second set of connecting features 72. The first set of connecting features 70 may be a portion of the threaded holes 24 in the end plate 22. The second set of connecting features 72 is at least partially distinct from the first set of connecting features 70. The second set of connecting features 72 may be a different portion of the threaded holes 24 in the end plate 22.

The kit 99 also includes a first set of physical features 74 for engaging a first building member in the form of, for example, a first guide 12, and a second set of physical features 76 for engaging a second building member in the form of, for example, a second guide 78. The first set of physical features 74 may be the unthreaded holes 69 in the first guide 22.

The second set of physical features 76 has at least one feature different from the corresponding feature of the first set of physical features 74. The second set of physical features 74 may be the unthreaded holes 80 in the second guide 78.

Fasteners in the form of, for example, bolts 26 may be inserted into the first set of physical features 74 in the form of the unthreaded holes 69 in the first guide 22 and may be threaded into the first set of connecting features 70 in the form of a portion of the threaded holes 24 of the first end plate 22 to secure the first guide 12 to the top plate 22 of the column 14.

Similarly, fasteners in the form of, for example, bolts 26 may be inserted into the second set of physical features 76 in the form of the unthreaded holes 80 in the second guide 78 and be threaded into the second set of connecting features 72 in the form of a portion of the threaded holes 24 of the end plate 22 to secure the second guide 78 to the top plate 22 of the column 14.

According to another aspect the end plate 22 may further include a third set of connecting features 82 for engaging a third building member in the form of, for example, a third guide 12. The third set of connecting features 82 is at least partially distinct from the first set of connecting features 70 or the second set of connecting features 72. The kit 99 also includes a third guide 86 having a third set of physical features 84. The third set of physical features 84 has at least one feature different from the corresponding feature of the first set of physical features 74 of the first guide 22 or the second set of physical features 76 of the second guide 78.

Fasteners in the form of, for example, bolts 26 may be inserted into the third set of physical features 84 in the form of the unthreaded holes 88 in the third guide 86 and may be threaded into the third set of connecting features 82 in the form of a portion of the threaded holes 24 of the end plate 22 to secure the third guide 86 to the top plate 22 of the column 14.

According to another aspect the end plate 22 may further include a fourth set of connecting features 90. The fourth set of connecting features 90 is at least partially distinct from the first set of connecting features 70, the second set of connecting features 72 or the third set of connecting features 82. The kit 99 may also include a fourth guide 94 having a fourth set of physical features 92. The fourth set of physical features 92 has at least one feature different from the corresponding feature of the first set of physical features 74, the second set of physical features 76 or the third set of physical features 84.

Fasteners in the form of, for example, bolts 26 may be inserted into the fourth set of physical features 92 in the form of the unthreaded holes 96 in the fourth guide 94 and may be threaded into fourth set of connecting features 90 in the form of a portion of the threaded holes 24 of the end plate 22 to secure the fourth guide 94 to the top plate 22 of the column 14.

According to another aspect, the kit 99 may further include one or more spacers 59 that may be positioned between the end plate 22 and at least one of the first guide 12, a second guide 78, a third guide 86 or the a fourth guide 94. The spacers 59 serve to raise, by the thickness of the spacers, the working height of the guides relative to the door 8 of the building 1.

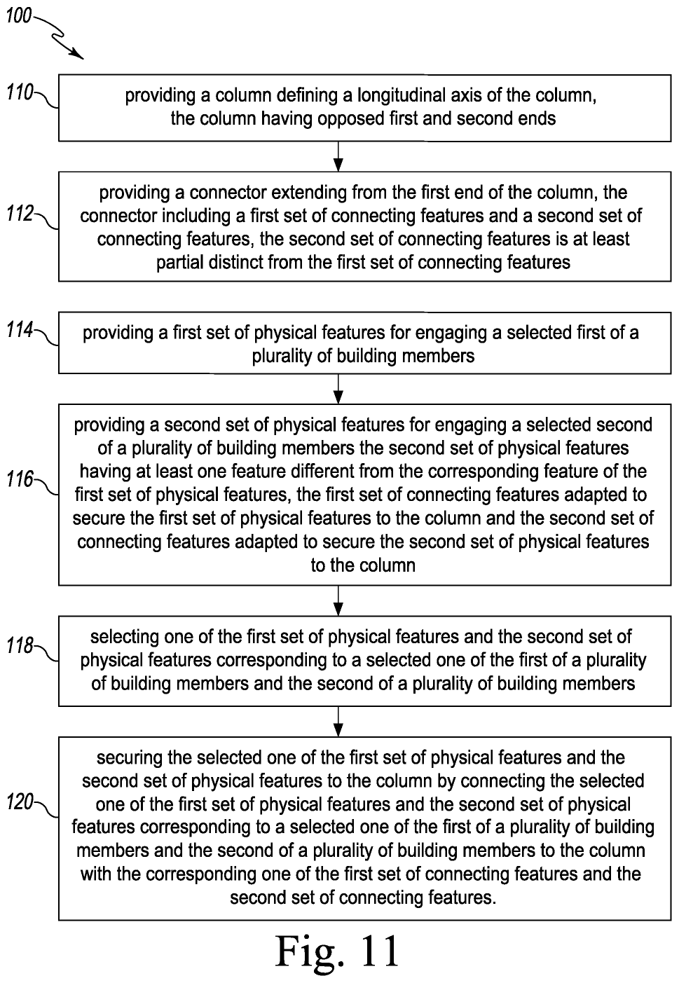

Referring now to FIG. 11 and according to another aspect of the present invention, a method 100 for providing a support for a selected one of a plurality of building members of a post frame building is provided. The method includes step 110 of providing a column defining a longitudinal axis of the column. The column has opposed first and second ends. The method further includes step 112 of providing a connector extending from the first end of the column. The connector includes a first set of connecting features and a second set of connecting features. The second set of connecting features is at least partially distinct from the first set of connecting features.

The method further includes step 114 of providing a first set of physical features for engaging a selected first of a plurality of building members.

The method further includes step 116 of providing a second set of physical features for engaging a selected second of a plurality of building members. The second set of physical features has at least one feature different from the corresponding feature of the first set of physical features. The first set of connecting features are adapted to secure the first set of physical features to the column and the second set of connecting features adapted to secure the second set of physical features to the column.

The method further includes step 118 of selecting one of the first set of physical features and the second set of physical features corresponding to a selected one of the first of a plurality of building members and the second of a plurality of building members.

The method further includes step 120 of securing the selected one of the first set of physical features and the second set of physical features to the column by connecting the selected one of the first set of physical features and the second set of physical features corresponding to a selected one of the first of a plurality of building members and the second of a plurality of building members to the column with the corresponding one of the first set of connecting features and the second set of connecting features.

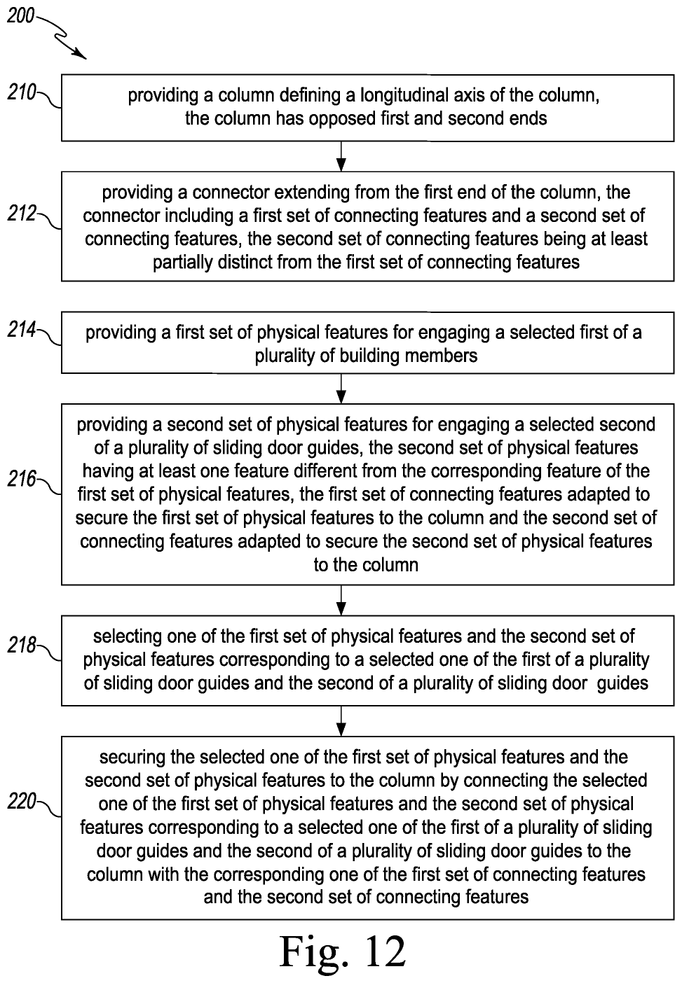

Referring now to FIG. 12 and according to another aspect of the present invention, a method 200 for providing a support for a selected one of a plurality of sliding door guides of a post frame building is provided. The method includes step 210 of providing a column defining a longitudinal axis of the column. The column has opposed first and second ends. The method further includes step 212 of providing a connector extending from the first end of the column. The connector includes a first set of connecting features and a second set of connecting features. The second set of connecting features is at least partially distinct from the first set of connecting features.

The method further includes step 214 of providing a first set of physical features for engaging a selected first of a plurality of building members.

The method further includes step 216 of providing a second set of physical features for engaging a selected second of a plurality of sliding door guides. The second set of physical features has at least one feature different from the corresponding feature of the first set of physical features. The first set of connecting features are adapted to secure the first set of physical features to the column and the second set of connecting features adapted to secure the second set of physical features to the column.

The method further includes step 218 of selecting one of the first set of physical features and the second set of physical features corresponding to a selected one of the first of a plurality of sliding door guides and the second of a plurality of sliding door guides.

The method further includes step 220 of securing the selected one of the first set of physical features and the second set of physical features to the column by connecting the selected one of the first set of physical features and the second set of physical features corresponding to a selected one of the first of a plurality of sliding door guides and the second of a plurality of sliding door guides to the column with the corresponding one of the first set of connecting features and the second set of connecting features.

Exemplary embodiments of a support column are described above in detail. The electric motor assembly and its components are not limited to the specific embodiments described herein, but rather, components of the column may be utilized independently and separately from other components described herein. For example, the components may also be used in combination with other devices, methods, and apparatuses, and are not limited to practice with only the systems and apparatus as described herein. Rather, the exemplary embodiments can be implemented and utilized in connection with many other applications.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the invention, including the best mode, and to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A support for use to support a guide for a sliding door for use in post frame construction, said support comprising:
a column defining a longitudinal axis thereof and having opposed first and second ends; and
a connector extending from the first end of said column, said connector including a plurality of sets of physical features with a selected one of the plurality of the sets of physical features for engaging the building member.

2. The support in accordance with claim 1, wherein at least a portion of said column is made of concrete.

3. The support in accordance with claim 2, wherein said column includes an elongated stem and a body extending radially outwardly from said stem.

4. The support in accordance with claim 3, wherein at least a portion of said stem comprises a metal rod.

5. The support in accordance with claim 3, wherein at least a portion of said body comprises concrete.

6. The support in accordance with claim 1, further comprising a selectively moveable stop extending from the second end of said column, said stop being selectively moveable with respect to said column along the longitudinal axis of said column.

7. The support in accordance with claim 6:
wherein said column includes a threaded member extending along the longitudinal axis of said column; and
wherein said stop defines threads configured to engage the threaded member.

8. The support in accordance with claim 1, wherein the selected one of the plurality of the sets of physical features for engaging the building member is removeably connected to said connector.

9. The support in accordance with claim 1, further comprising a spacer extending from the connector and engaging the guide.

10. The support in accordance with claim 1, further comprising a stop extending from the second end of said column, said stop being moveable with respect to said column along the longitudinal axis of said column.

11. The support in accordance with claim 10, wherein said stop is selectively moveable with respect to said column along the longitudinal axis of said column.

12. The support in accordance with claim 11:
wherein said column includes a threaded member extending along the longitudinal axis of said column; and
wherein said stop defines threads configured to engage the threaded member.

13. A kit for engaging a selected one of a plurality of guides for guiding the door of a post frame building, said kit comprising:
a column defining a longitudinal axis thereof and having opposed first and second ends;
a top plate extending from the first end of said column, said top plate including a first set of connecting features and a second set of connecting features, said second set of connecting features is at least partially distinct from said first set of connecting features;
a first guide having a first set of physical features for cooperating with the first set of connecting features for securing the first guide to the column; and
a second guide having a second set of physical features for cooperating with the second set of connecting features for securing the second guide to the column, said second set of physical features having at least one feature different from the corresponding feature of said first set of physical features.

14. The kit in accordance with claim 13, wherein at least a portion of said column is made of concrete.

15. The kit in accordance with claim 13, wherein said column includes an elongated stem and a body extending radially outwardly from said stem.

16. The kit in accordance with claim 15, wherein at least a portion of said stem comprises a metal rod.

17. The kit in accordance with claim 13, further comprising a selectively moveable stop extending from the second end of said column, said stop being selectively moveable with respect to said column along the longitudinal axis of said column.

18. The kit in accordance with claim 17:
wherein said column includes a threaded member extending along the longitudinal axis of said column; and
wherein said stop defines threads configured to engage the threaded member.

19. The kit in accordance with claim 13, further comprising a spacer positioned between the top plate and the first end of said column.

20. A method for providing a support for a selected one of a plurality of sliding door guides of a post frame comprising:
providing a column defining a longitudinal axis of the column, the column having opposed first and second ends;
providing a connector extending from the first end of the column, the connector including a first set of connecting features and a second set of connecting features, the second set of connecting features being least partially distinct from the first set of connecting features;
providing a first set of physical features for engaging a selected first of a plurality of building members;
providing a second set of physical features for engaging a selected second of a plurality of sliding door guides, the second set of physical features having at least one feature different from the corresponding feature of the first set of physical features, the first set of connecting features adapted to secure the first set of physical features to the column and the second set of connecting features adapted to secure the second set of physical features to the column;
selecting one of the first set of physical features and the second set of physical features corresponding to a selected one of the first of a plurality of sliding door guides and the second of a plurality of sliding door guides; and
securing the selected one of the first set of physical features and the second set of physical features to the column by connecting the selected one of the first set of physical features and the second set of physical features corresponding to a selected one of the first of a plurality of sliding door guides and the second of a plurality of sliding door guides to the column with the corresponding one of the first set of connecting features and the second set of connecting features.
